(19) United States
(12) Patent Application Publication
(10) Pub. No.: US 2014/0009013 A1
(43) Pub. Date: Jan. 9, 2014

(54) STATOR TORQUE RETENTION FEATURE FOR A CAST-IN STATOR ASSEMBLY

(71) Applicants: Brad Chamberlin, Pendleton, IN (US); Colin James Hamer, Noblesville, IN (US)

(72) Inventors: Brad Chamberlin, Pendleton, IN (US); Colin James Hamer, Noblesville, IN (US)

(73) Assignee: REMY TECHNOLOGIES, LLC, Pendleton, IN (US)

(21) Appl. No.: 13/543,104

(22) Filed: Jul. 6, 2012

(51) Int. Cl. H02K 9/22; H02K 9/19

(52) U.S. Cl. 310/54; 310/52

(57) ABSTRACT

An electric machine is disclosed having a stator and a rotor, the stator comprising one or more windings that “turn” between passes through the stator. The turn portions of the windings are cast within a heat-conductive material such as aluminum that conducts heat away from the turn portions. The casting also defines a cavity for the flow of a heat-carrying fluid (such as water) to remove heat more efficiently from the turn portions. In some embodiments, the windings are electrically insulated (for example, using a ceramic insulator) before the casting.

### REFERENCE TO RELATED APPLICATIONS

The present application is related to U.S. application Ser. No. 13/236,685, Attorney Docket 23475-95254 which was filed Sep. 20, 2011, under the title “Electrical Machine with Winding Conductor Having Ceramic Insulation, incorporated herein by reference in its entirety.”

### FIELD OF THE INVENTION

Various embodiments of the present invention pertain to methods and apparatus for retaining the stator of an electric machine within another member, and yet other embodiments pertain to methods and apparatus for improved transfer of heat from an electric machine.

### SUMMARY OF THE INVENTION

Some embodiments of the present invention include aspects related to the fabrication of a subassembly for an electric machine that includes non-cast components that are located in the casting of another component that is in contact with the non-cast component. Yet other embodiments of the present invention include aspects pertaining to the casting of features surrounding a stator for an electric machine.

Still other embodiments include aspects pertaining to the fabrication of a stator with conductive windings in which portions of the windings are mechanically held together in a matrix of a cast metal.

One aspect of some embodiments pertains to an apparatus for an internal permanent magnet electrical machine, including a cylindrical stator assembly fabricated from a first material. Another embodiment includes a cylindrical member surrounding a portion of the stator, the member being cast from a molten second material in substantial contact with the outer surface of the stator, wherein the melting point of the second material is lower than the melting point of the first material.

Another aspect of some embodiments pertain to a method of making an electric machine, including fabricating a stator having a stator body and at least one electrically conductive winding. The winding includes a plurality of body portions that each pass through the stator body and a plurality of turn portions joining the body portions outside the stator body. Still other embodiments include casting a material to fill at least part of the volume that contains the turn portions.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein have been created from scaled objects of a computer model. It is understood that such dimensions, or the relative scaling within a figure, are by way of example, and not to be construed as limiting.

FIG. 1 is a top, front, right side perspective representation of an internal permanent magnet motor according to one embodiment of the present invention.

FIG. 2 is a front, top, right side perspective view of a cast housing of the apparatus of FIG. 1.

FIG. 3 is a cross sectional view of the apparatus of FIG. 2 as taken along a vertical plane passing through the centerline.

FIG. 4A is a front elevational view of a stator assembly according to one embodiment of the present invention.

FIG. 4B is a top, front, right side perspective view of the apparatus of FIG. 4A.

FIG. 5A is a front elevational view of the stator of FIG. 4A with the housing of FIG. 2 cast around the stator, according to one embodiment of the present invention.

FIG. 5B is a cross sectional view of the apparatus of FIG. 5A as taken along line 5B-5B.

FIG. 6 is an exploded view of a stator and sleeve according to another embodiment of the present invention.

FIG. 7 is a cross sectional view of the sleeve of FIG. 6.

FIG. 8 is a cross sectional view of a stator with the sleeve of FIG. 7 cast around the stator, according to another embodiment of the present invention.

FIG. 9 is a front elevational view of a stator assembly according to another embodiment of the present invention.

FIG. 10A is a front elevational view of the stator of FIG. 9 with a housing cast around the stator according to another embodiment of the present invention.

FIG. 10B is a cross sectional view of the apparatus of FIG. 10A as taken along line 10B-10B. FIG. 11A is a cross sectional view of a stator with a sleeve cast around the stator according to another embodiment of the present invention.

FIG. 10C is a cross sectional view of an apparatus similar to that of FIG. 10B except using a key in the structural interface between the stator and housing, according to another embodiment of the present invention.

FIG. 11B is a cross sectional view of the apparatus of FIG. 11A as taken along line 11B-11B.

FIG. 12A is a front elevational view of a stator plate according to another embodiment of the present invention.

FIG. 12B is a front elevational view of a plurality of the plates of FIG. 12A assembled together.

FIG. 13 is a perspective view of a stator.

FIG. 14 is a partial cross-section of a stator in an electrical machine according to another embodiment of the present invention.

FIG. 15 is a cross-section of the electrical machine of FIG. 14.

FIG. 16 is a flowchart illustrating a manufacturing process according to another.

FIG. 17 is a schematic cutaway representation of a motor according to another embodiment of the present invention.

FIG. 18 is a cross-sectional view of the apparatus of FIG. 17 as taken along line 18-18.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims.

The use of an N-series prefix for an element number (NXX.XX) refers to an element that is the same as the non-prefixed element (XX.XX), except as shown and described thereafter. The usage of words indicating preference, such as “preferably,” refers to features and aspects that are present in at least one embodiment, but which are optional for some embodiments. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. This description convention also applies to the use of prime (′), double prime (″), and triple prime (′″) suffixed element numbers. Therefore, it is not necessary to describe the features of 20.1, 20.1′, 20.1″, and 20.1′″ that are the same, since these common features are apparent to persons of ordinary skill in the related field of technology.

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

Various embodiments of the present invention pertain to the fabrication of an assembly for an electrical machine that includes a first component that is cast in substantial contact with a second component. In some embodiments, the second component is a stator, and in yet other embodiments the stator includes a plurality of conductive windings electrically insulated and arranged in a plurality of parallel electrically conductive paths. In yet other embodiments, the windings are insulated with a ceramic material. Preferably, the materials of the stator assembly are chosen to have melting points that are higher than the melting point of the cast material. Although reference will be made to embodiments pertaining to electrical motors having permanent magnets, including motors with surface permanent magnets and internal permanent magnet mounted on a rotor, it is understood that some embodiments of the present invention pertain to electrical machines in general.

This transmittal of power from stator to rotor imposes environments upon the stator in terms of both torque and heat. With regards to the former, the interaction of the stator and rotor imposes a torque on the rotor that is used to drive the vehicle (such as a rotational power input to a transmission that subsequently results in power being transmitted to one or more wheels of the vehicle). The torque imposed on the rotor by the stator is likewise reacted by an equal and opposite torque of the stator on its surroundings. With reference to motor 10, this reactive torque is passed from the stator to housing 11, and from the mounting features of the housing to the vehicle frame.

In some motors, the stator assembly 20 is received within a pocket of a housing, and this fit is accomplished after heating or cooling of the housing and/or the stator. For example, the stator assembly 22 can be reduced in temperature with a resultant reduction in its outer diameter as a result of a thermal contraction. Likewise, the housing can be heated so that the inner diameter of the pocket increases. By using one or both of these thermal effects, a cold stator can be placed within a warm housing (with the possibility of the fit between the two being an interference fit even with the temperature differential), such that when the stator and housing return to the same temperature, the stator is effectively locked in place by friction with its outer diameter being in a state of residual compression, whereas the inner diameter of the housing is in a state of residual tension.

However, the stator and housing should be designed to support these residual stresses, along with other stresses imposed by operation of the motor. Such an accounting for these residual stresses can result in a stator and a housing that both contain additional material and/or stronger material, as compared to a stator and housing that do not encounter such residual assembly stresses.

In these known motors, the reactive torque of the stator is transferred by the friction of the interference fit (potentially a combination of both thermally-created interference and mechanically designed interference) to the walls of the housing. As previously discussed, the walls of the housing and the material of the stator must be adapted and configured to withstand these residual stresses superimposed upon other operational stresses. Further, the manufacturing processes involved in such manufacturing and assembly methods can be expensive. As examples, to achieve the interference fit the outer diameter of the stator and the inner diameter of the housing must be machined to close tolerances. Further, the use of temperature differences during the assembly process can bring with it the expense of temperature controlled chambers for processing of the stator and housing.

Yet another aspect of the environment of the stator and housing is the heat that needs to be dissipated during operation. Because of various inefficiencies in motor 10 (including for example ohmic heating of the conductors within the stator slots) a portion of the power provided to the motor generates heat. The heat of the stator is typically conducted into the housing, and thereafter removed by coolant flowing within cavities or passages 11.4. However, the conductance of heat from stator to housing is negatively impacted by a less than ideal heat transfer interface from stator OD to housing ID. For example, the outer diameter of some stator assemblies are machined, and any machining grooves (even if small) limit the amount of surface area in contact between the stator and housing. Such limitations on the surface area are also provided by any machining marks on the ID of the housing.

Some embodiments of the present invention include the casting of a component surrounding some or all of the outer surface of the stator. In such embodiments a stator having a rough outer surface can provide improved heat transfer into the cast material, including those embodiments in which the outer stator surface includes features that have a size, shape, or surface roughness such that the molten cast material comes into intimate contact with the features. In such embodiments, the roughness of the outer surface provides a larger surface for conductive heat transfer than what would have been provided by the interface of a stator with a machined outer diameter and a housing with a machined inner diameter.

Various embodiments of the present invention pertain to stators that are outer components surrounding a permanent magnet rotor, and further includes embodiments in which a permanent magnet rotor surrounds an internally located status. Some embodiments of the present invention pertain to stators in which the laminates 22 and conductors 24 are placed circumferentially around an inner diameter of a rotor that includes magnets. However, yet other embodiments of the present invention pertain to motors in which the laminate assembly 22 and the conductors 24 are surrounded by a rotor such that the magnets are located proximate to the inner diameter of a rotating housing of the rotor assembly.

Generally, another embodiment of the present system pertains to an electric machine having a rotor and a stator. The windings of the stator comprise “turn” portions that connect the portions of the wire that go through the stator body. The turn portions are cast inside a heat-conductive material so that the material substantially—if not completely—envelops the turn portions. The casting in some embodiments includes a channel through which fluid flows, carrying ohmic heat away from the windings.

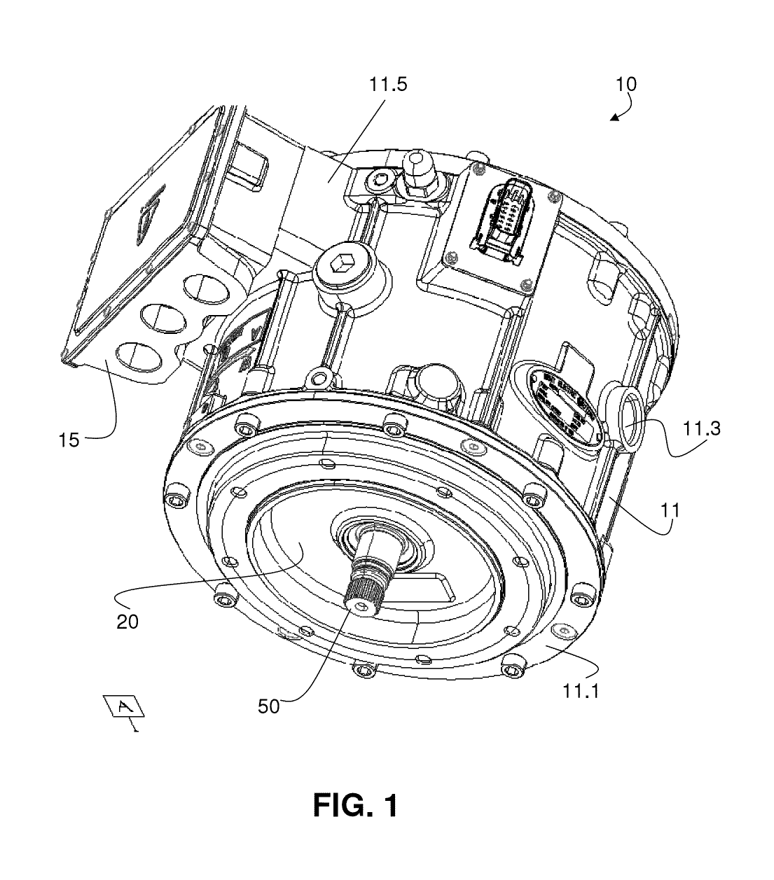

FIG. 1 is a perspective view of an internal permanent magnet motor 10 according to one embodiment of the present invention. Motor 10 includes a housing 11 that is adapted and configured as an interface between a support structure (such as a frame for a vehicle having electric propulsion) and the rotor 50 and stator 20 assemblies. Housing 11 includes various features for interfacing with the vehicle, such as receptacles 11.5 that receive high voltage conductors in electrical communication with windings passing within slots of the stator assembly, receptacle 11.5 include provisions for attachment of a terminal block 15 which interfaces the conductors of the stator with the vehicle electrical power system. Although what has been shown and described is an internal permanent magnet motor 10 used in a vehicle (such as an automobile, bus, truck, construction vehicle, or the like), the present invention is not so limited, and includes those embodiments in which an electric motor is used in any type of application.

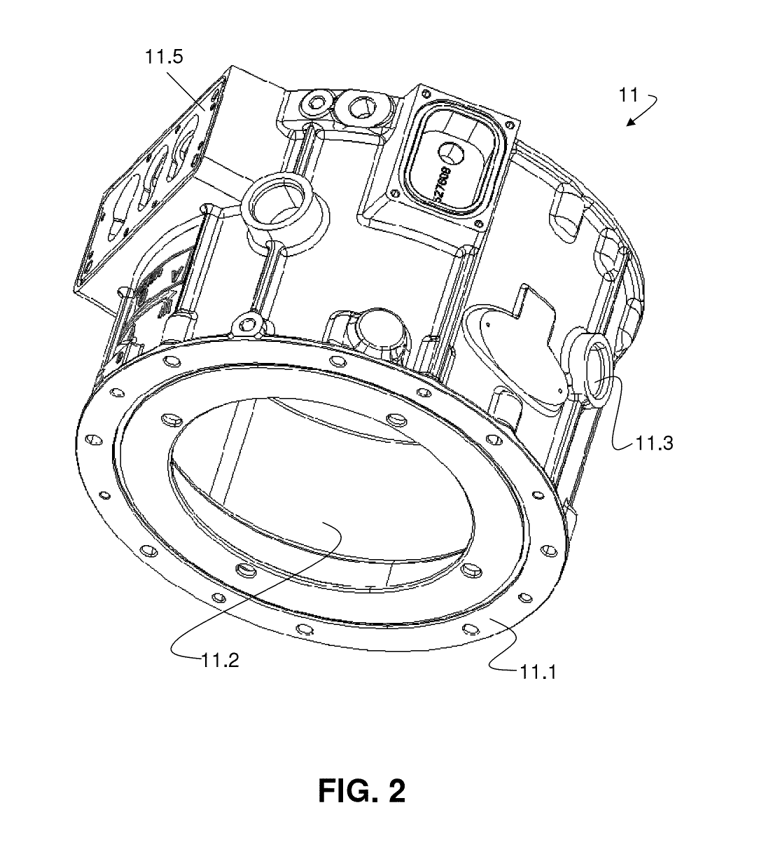

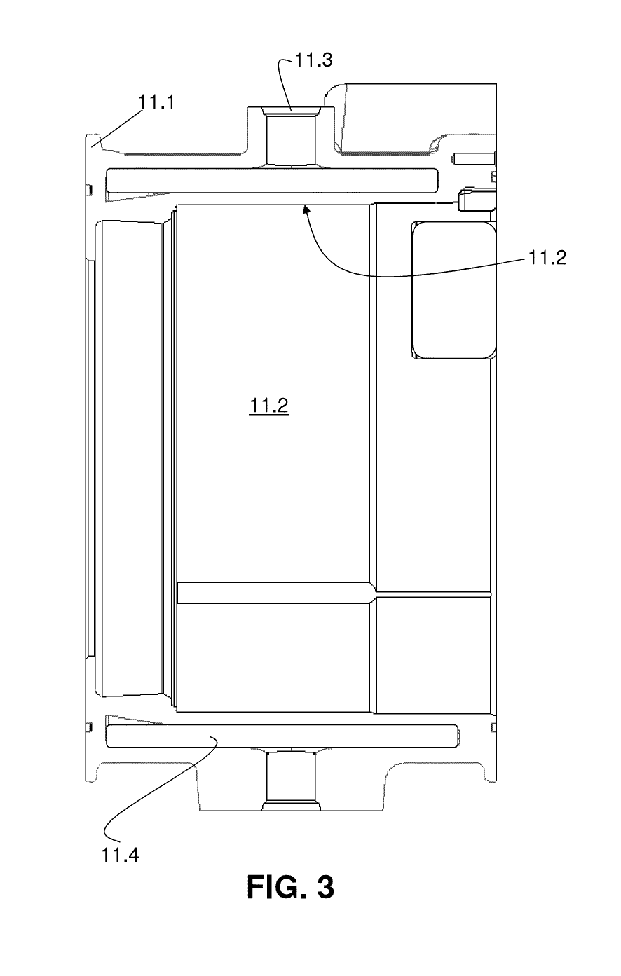

Referring also to FIGS. 2 and 3, further details of housing 11 can be seen. Housing 11 includes a mounting flange 11.1 that is adapted and configured for mounting and alignment on a structure, such as a frame of a vehicle. Housing 11 further includes a plurality of cooling ports 11.3 that are adapted and configured to provide coolant to flow within an internal cooling passage 11.4. Referring to FIG. 3, it can be seen that cooling cavity 11.4 substantially surrounds an inner diameter 11.2 of housing 11 that is adapted and configured to receive within it a stator assembly.

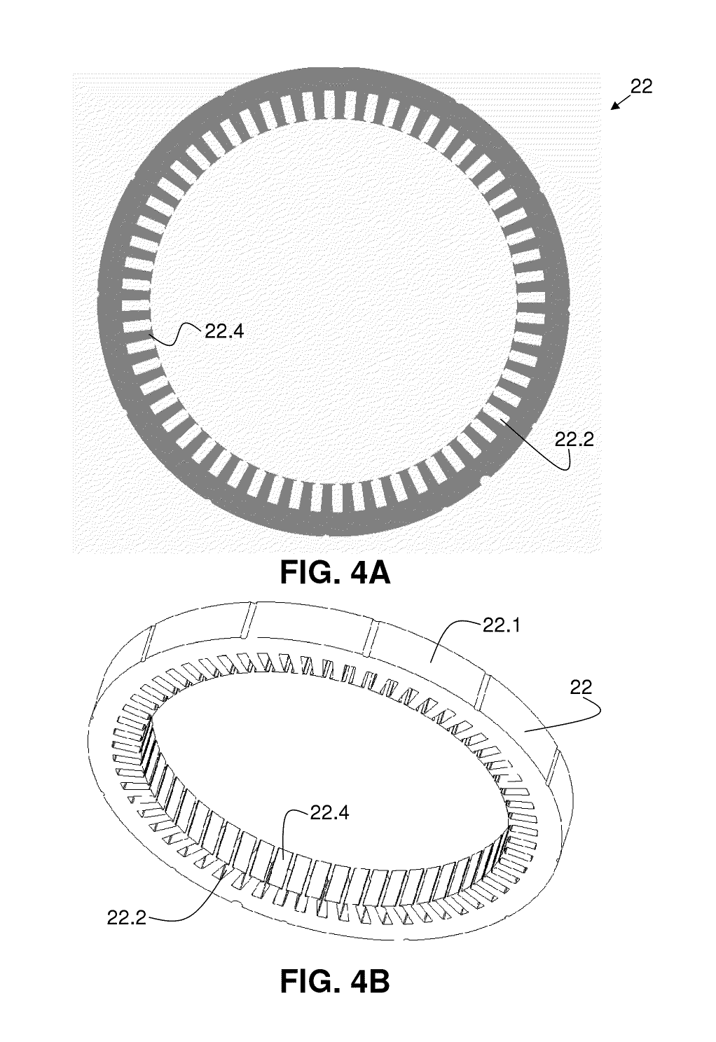

FIGS. 4A and 4B present a frontal shaded view and a perspective non-shaded view, respectively, of a portion of a laminate assembly 22. Laminate assembly 22 comprises a plurality of equally-spaced slots or pockets 22.2 that extend circumferentially between the inner and outer diameters 22.4 and 22.1, respectively. Inner diameter 22.4 is adapted and configured to receive within it a rotor assembly 50 that includes a plurality of permanent magnets (not shown). Electrical conductors (not shown) within slots 22.2 provide a rotating magnetic field that interacts with the magnetic fields of the permanent magnets to transmit mechanical power from stator assembly to rotor assembly 50.

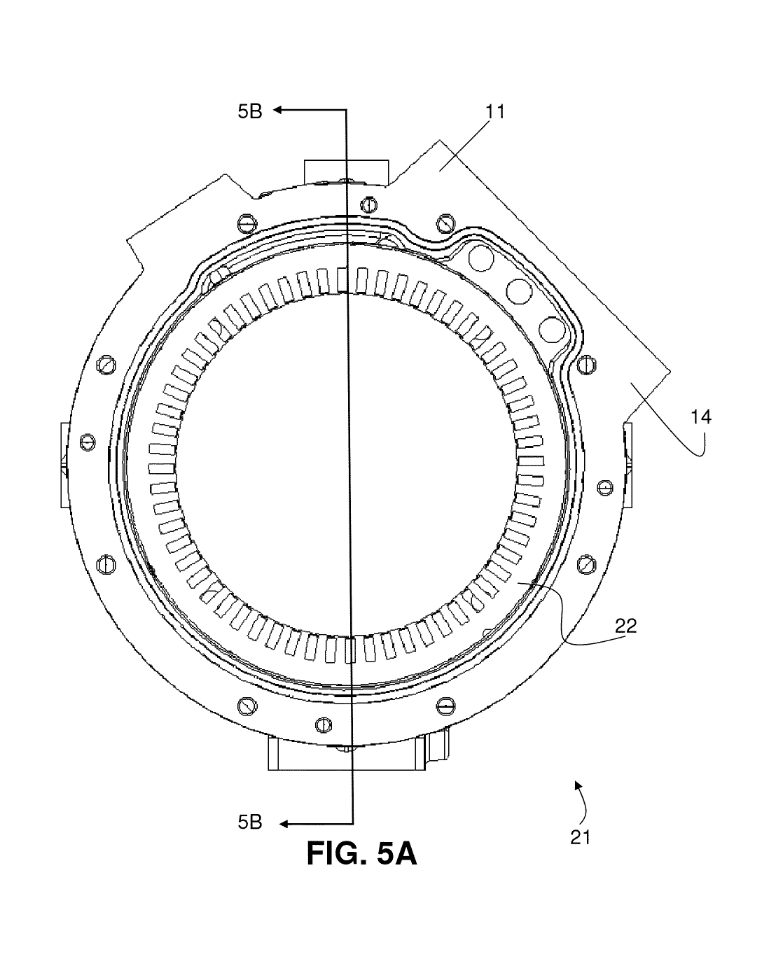

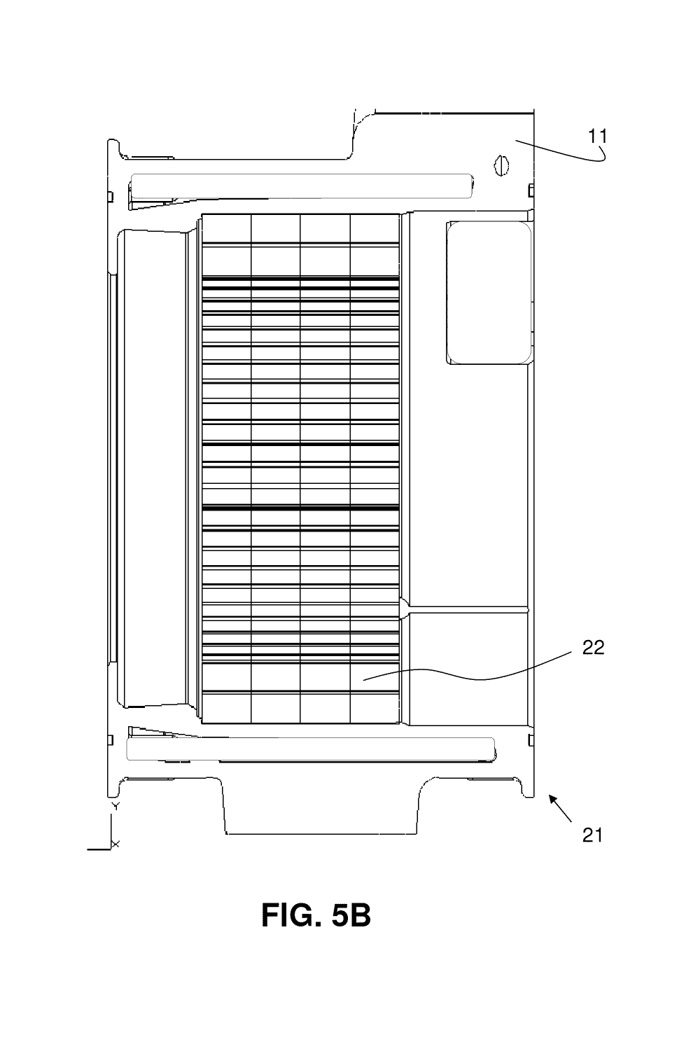

FIGS. 5A and 5B show one embodiment of the new invention that includes features to provide improved transfer of torque and improved transfer of heat. FIGS. 5A and 5B show a subassembly 21 that is a hybrid of cast and machined parts. Subassembly 21 includes a machined stator laminate assembly 21 located within a cast housing 11. In one embodiment, the stator assembly 22 comprises a plurality of substantially identical plates that are aligned with one another into a cylindrical assembly. This laminate assembly 22 is then located within a plurality of casting fixtures.

These casting fixtures are adapted and configured to fabricate a cast housing 11 that is cast around the machined stator assembly 22. In some embodiments these casting fixtures are adapted and configured to generally locate the inner diameter 22.4 of laminate assembly 22 relative to one or more mounting features of housing 11, such as mounting flange 11.1. In providing such general alignment, the cast/machined subassembly 21 requires less subsequent machining to provide accurate alignment between the centerline of laminate assembly 22 and various locating features of flange 11.1, such as holes for fasteners and dowel pins.

In some embodiments, the outer surface 22.1 of laminate assembly 22 does not need to be machined prior to having the housing cast around it. Such machining may not be required in those embodiments where the casting process is adapted and configured such that the molten material is able to flow into close contact with the outer surface of that laminated stator.

Further, in some embodiments the laminated stator comprises a plurality of individually stamped plates fabricated from a material such as a ferrous material. In some embodiments the as-stamped outer surfaces of the plates are sufficient in terms of surface finish and diameter variation to be in contact with the molten material during the casting procedure. In such embodiments, the casting material flows sufficiently freely so as to generally conform to the rougher, as-stamped outer surface. As one example, a housing 11 or a sleeve 14 can be cast from a material with a lower melting point than the melting point of the plate material. In some embodiments, the housing or sleeve are cast from a material including aluminum.

In yet other embodiments, the individual plates of the stator assembly have an outer diameter that is either non-circular, or circular about an axis different than the axis of the inner diameter. In such embodiments, the laminate plates are substantially identical to one another. However, as they are stacked together to form the stator assembly, the individual plates are angularly displaced relatively to one another (i.e., clocked relative to one another), such that the composite outer diameter of the stator is non cylindrical, whereas the inner diameter of the stator remains cylindrical (to later receive within it the outer diameter of the rotor). In such embodiments the outer surface of the stator has an outer diameter that varies both circumferentially and axially. Such an irregular outer surface of the stator assembly provides its own locking within the housing as the molten cast material solidifies. It is appreciated that the housing shown in FIGS. 3, 5A, and 5B include various locating and alignment features that may be machined into the cast subassembly 21 after the casting process is complete, although these locating and alignment features may be introduced by any method.

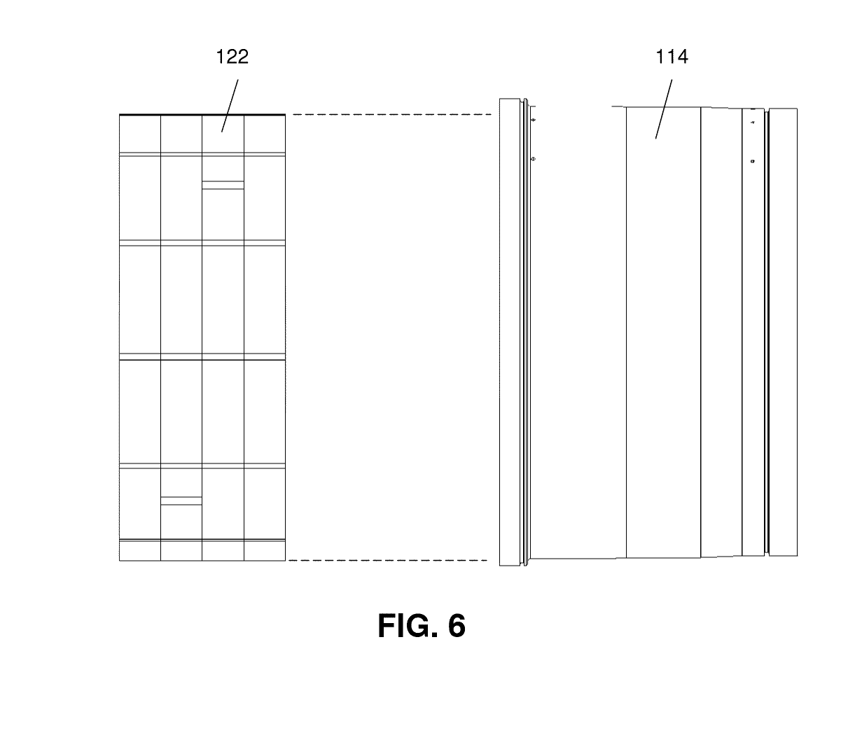

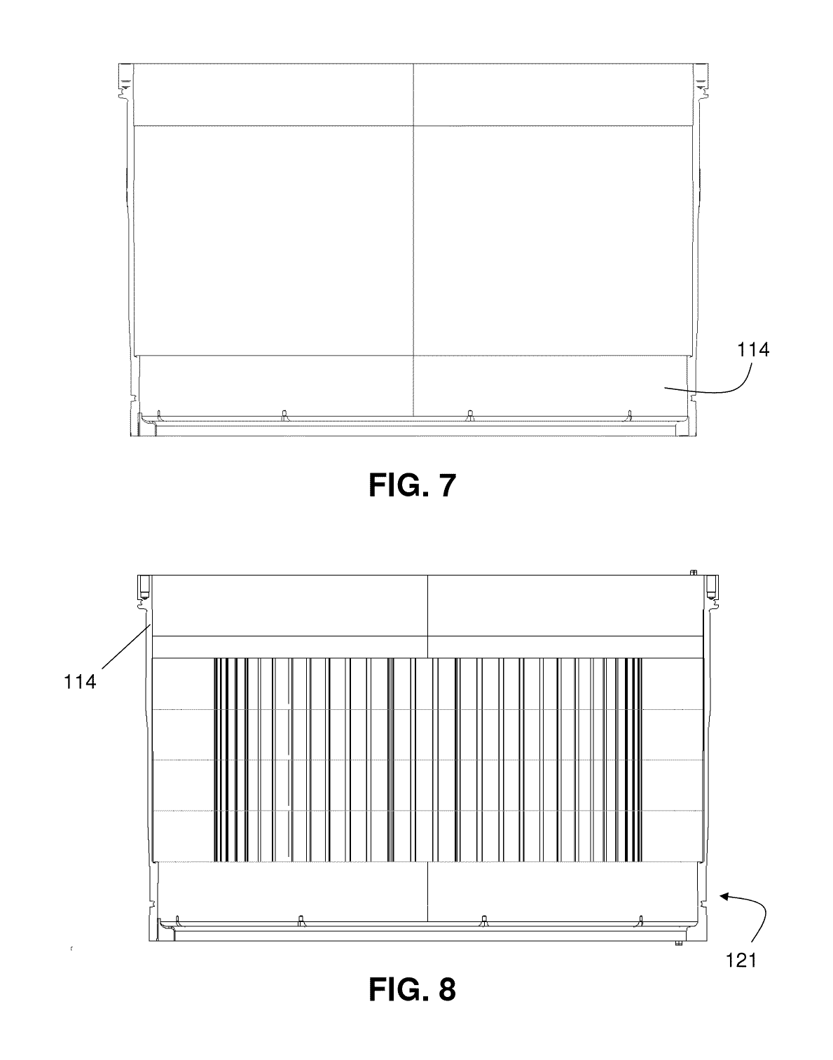

FIGS. 6, 7, and 8 depict yet another embodiment of the present invention. In another embodiment, a motor includes a stator assembly 122 contained within a sleeve 114. Sleeve 114 is preferably a thin-walled cylindrical member as best seen in FIG. 7. In some motors, a sleeve 114 is retained within the inner diameter 111.2 of a housing. In such embodiments, the sleeve 114 provides an apparatus for readily interfacing stators of different configurations into a particular housing, or interfacing a particular stator into different configurations of housing. As one example, the outer surface features of sleeve 114 remain substantially consistent across different motor product lines (so as to provide a routine interface to different housings), but have interior features that vary depending upon the outer surface of the stator assembly.

FIG. 8 shows a subassembly 121 comprising a machined stator subassembly 122 that has had a sleeve 114 cast around it. Preferably, stator subassembly 122 is fabricated from a ferrous material having a first, higher melting temperature. Preferably, sleeve 114 is cast from a second, different material that has a lower melting temperature, such as an aluminum composition.

In some embodiments, a stator assembly 122 is located relative to a plurality of casting fixtures. These fixtures establish an axial location of stator 122 relative to various features of sleeve 114. Further, these casting fixtures prevent the flow of molten cast material into any of the slots or pockets 122.2 of stator 122. It is appreciated that the sleeve shown in FIGS. 6, 7, and 8 includes various locating and alignment features that have been incorporated into the cast subassembly 121 after the casting process

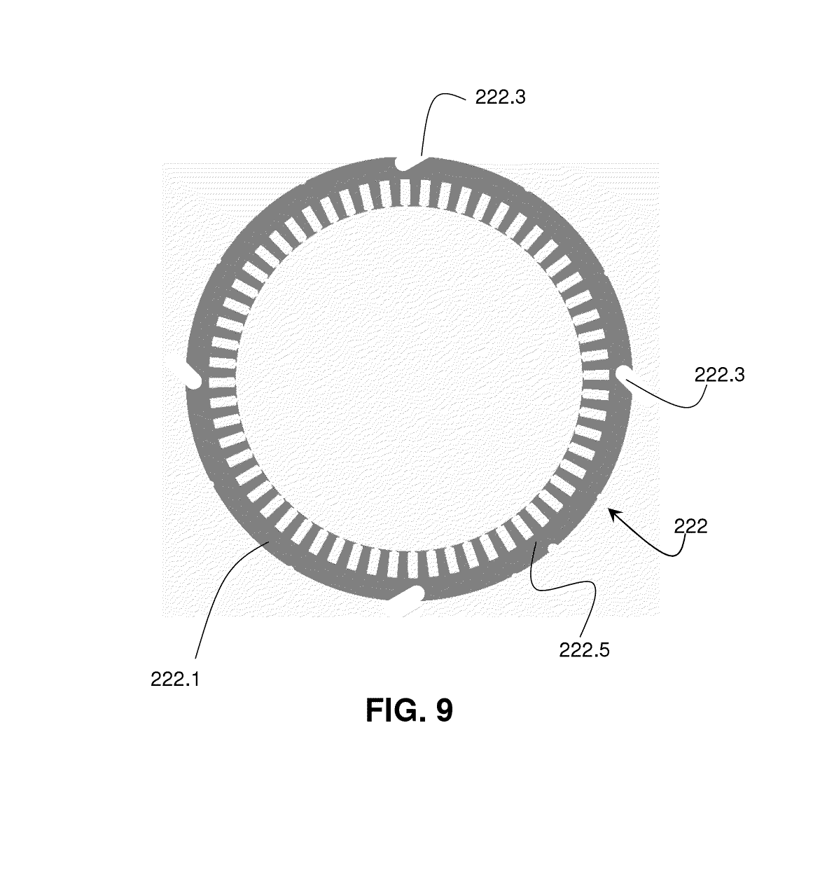

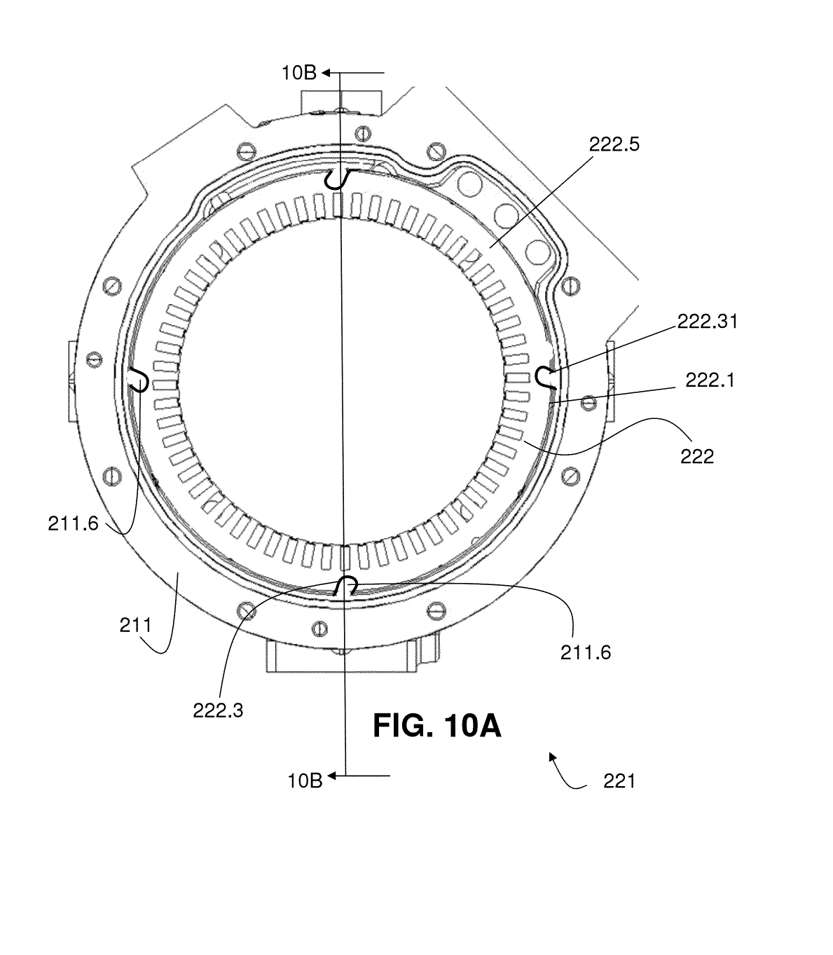

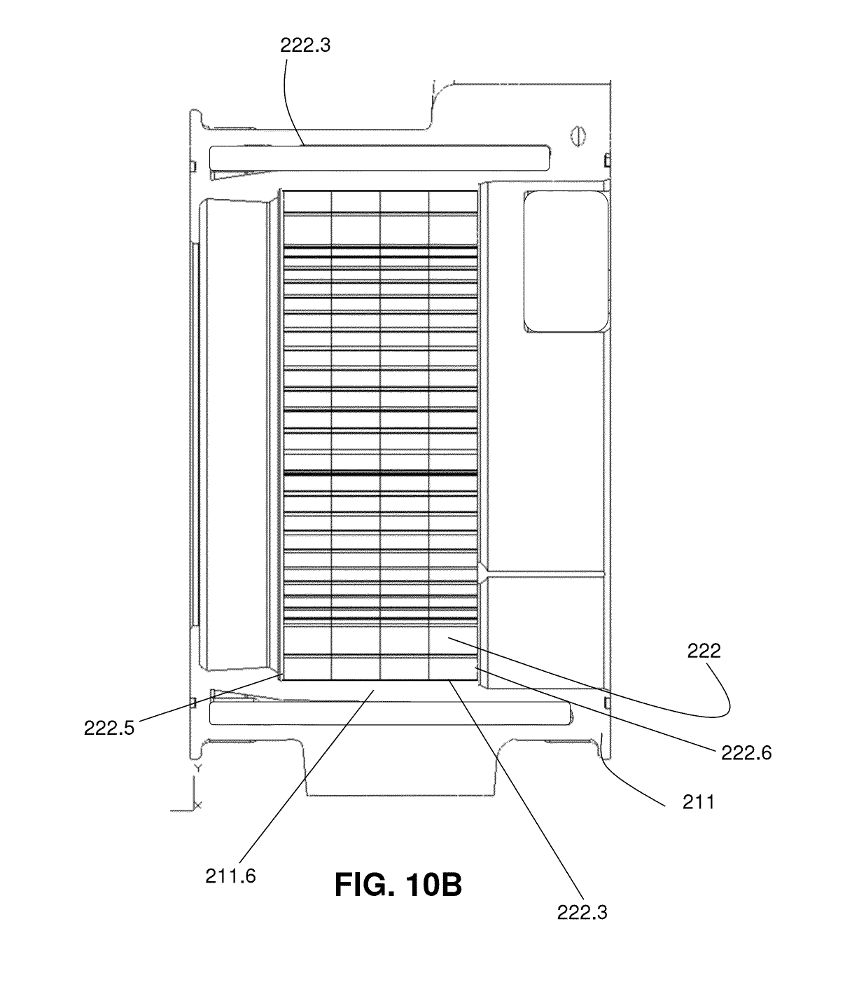

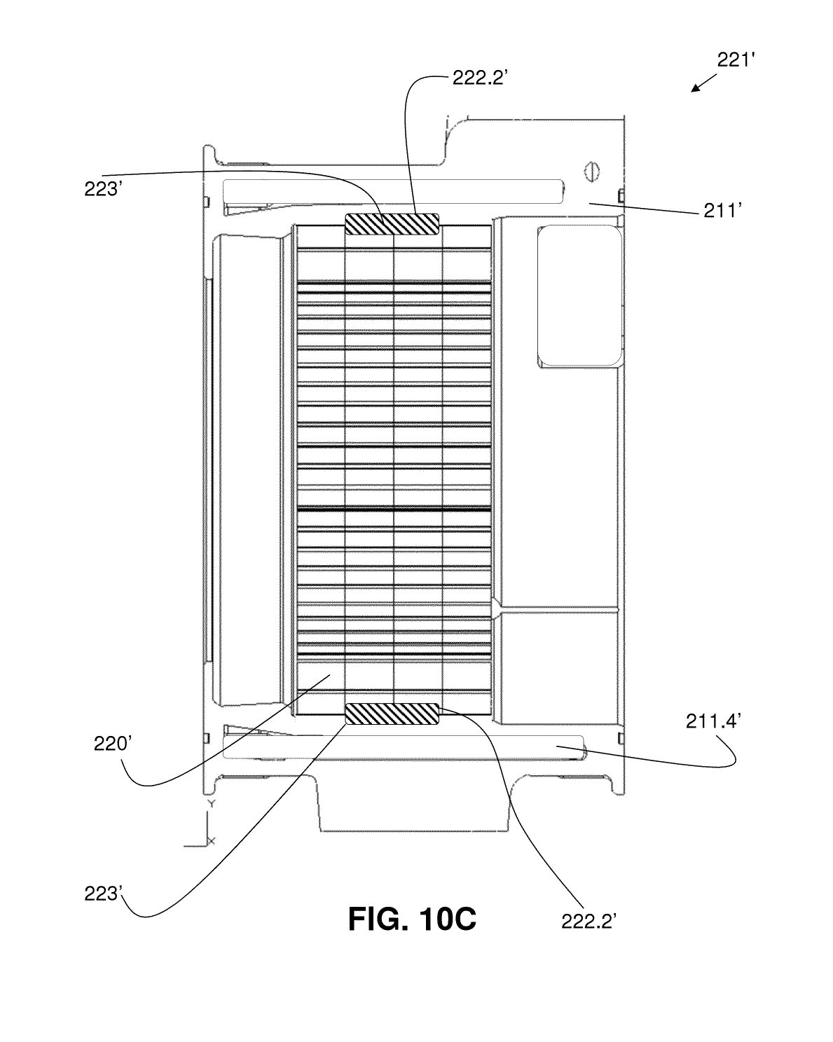

FIGS. 9, 10A and 10B depict various aspects of yet another embodiment of the present invention. FIG. 9 shows a frontal view of a stator subassembly 222. Subassembly 222 includes a plurality of retention features 222.3 (such as grooves) that are spaced apart around the circumference of the outer surface 222.1. Preferably, retention features 222.3 are adapted and configured so as to come into intimate contact with the molten cast material during the casting process. Preferably, these retention features are grooves relatively open and smooth for the free flow of casting material onto the surfaces of the retention features. In FIG. 9, retention features 222.3 comprise a plurality of pockets that are preferably stamped into the outer surface of the laminate plates that comprise stator assembly 222. However, the present invention also contemplates retention features that project outwardly from outer surface 222.1, such as a plurality of circumferentially-spaced apart tabs or projections.

The retention features 222.3 shown in FIGS. 9 and 10 are further configured such that the surfaces of the retention feature have a geometric aspect that is at least partly tangential to the cylindrical outer surface 222.1. In FIG. 9, each of the retention features have the same orientations, although the present invention is not so limited, and includes retention features that are oriented different relative to one another.

Referring to FIG. 10, the stator assembly 222 is shown located within a housing 211 that has been cast to surround stator 222. In a manner as previously described, stator 222 is located relative to a plurality of casting fixtures, such that the molten cast material is able to flow in intimate contact with both the outer surface 222.1 and the surfaces of the retention features 222.3, and thereafter solidify into a shape that is substantially complementary to the shape of the outer surface 222.1 and the retention features 222.3. Further, these casting features provide various external features and cooling passages as previously described.

FIGS. 10A and 10B show that the molten casting material substantially fills each retention feature 222.3 and solidifies into a complementary-shaped, mating retention feature 211.6. As shown and described in these figures, the stator assembly includes female retention features, and the cast housing 211 includes male features. However, the present invention also contemplates those embodiments in which the stator assembly includes a plurality of male features that are subsequently surrounded during the casting process by female features.

FIG. 10B shows that the retention features 211.6 and 222.3 extend substantially along the entire length of laminate stator assembly 222, from the first face 222.5 to the second face 222.6. The lengthwise extent of the retention features and further the lengthwise extent of the casting, provides for maximum surface area for the transfer of heat. However, the present invention also contemplates those embodiments in which the cast interface between the housing (or sleeve) and the stator is less than the entire length of the stator.

Referring to FIG. 10A, it can be seen that the angular orientation of retention features 222.3 and 211.6 are adapted and configured to provide a different torsional loading for clockwise torques (applied from stator to housing), as compared to counterclockwise applied torques. In those cases in which stator 222 is providing a reactive torque in a clockwise direction upon housing 211, a portion of the material in retention feature 211.6 is placed in compression. Further, the interior corner 222.31 of stator retention feature 222.3 is received within a complementary-shaped closed corner of the cast retention feature. Preferably, the corner diameters are adapted and configured for suitably low stress concentrations. Yet other embodiments of the present invention contemplate retention features that do not include an angular offset, as will be shown and described in the next embodiment.

FIG. 10C is a cross sectional view of a hybrid cast and fabricated structure 221′ similar to that shown in FIG. 10B. Structure 221′ includes a separate key 223′ that is placed within a slot or pocket 222.2′ of laminate assembly 220′ In some embodiments, laminate plates 222.7′ are stamped substantially identically, each having a pocket 222.2′ However, in some embodiments the plates proximate the fore and aft faces of the stator assembly are registered out of alignment with the pockets extending across the inner plates of the stator assembly and forming a single, compound pocket. In such embodiments, compound pocket 222.2′ extend substantially along the middle of the stator assembly 220′.

A separate key 223′ such as a steel key can be inserted into the central, compound slot 222.2′ The housing 211′ is then cast around the stator and key. The molten casting material comes into contact with the keys, such that the solidified material, key, and stator assembly are substantially locked together.

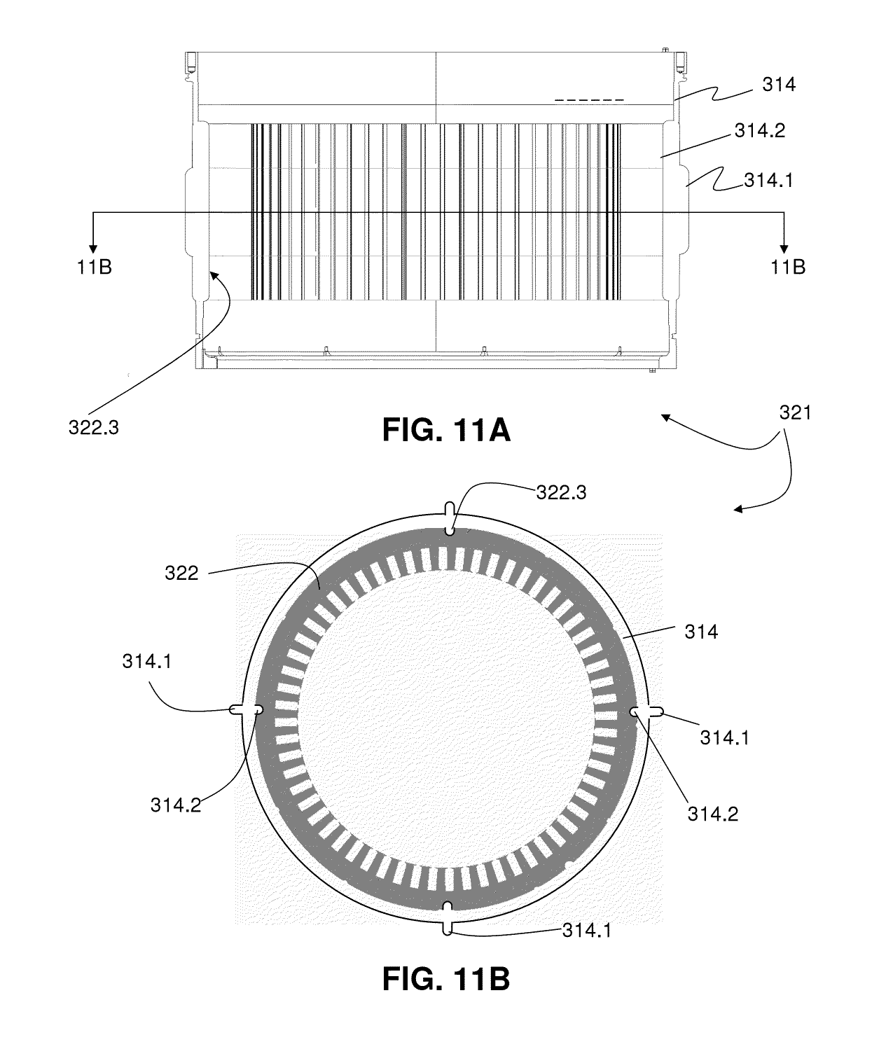

FIGS. 11A and 11B show cutaway and sectional views, respectively, of an apparatus according to another embodiment of the present invention. FIG. 11A is a cutaway of a cast assembly 321 as taken along a plane containing the axis of the inner diameter. FIG. 11B is a cross section of FIG. 11A, but with the entire circumferential extent of cast assembly 321 restored in the view for the sake of clarity.

Laminate assembly 322 includes a plurality of pockets 322.3 spaced apart circumferentially around the outer surface of assembly 322. In some embodiments, these pockets 322.3 are generally symmetrical about a centerline, and that centerline intersects the longitudinally-extending axis of the stator inner diameter. In comparison to retention features 222.3, retention features 222.3 are substantially symmetrical about their respective centerlines.

FIGS. 11A and 11B show a subassembly 321 including a ferrous stator assembly 322 that has cast around it a sleeve 314. In a manner previously described, stator assembly 322 is located within a plurality of casting fixtures, these fixtures both establishing various sleeve features and further protecting the slots and inner diameter of the laminate stator assembly from contacting casting material. Housing 314 is cast to include a plurality of retention features 314.1 on the outer surface of the housing. These retention features 314.1 can be either male or female in shape.

Cast subassembly 321 further includes a plurality of cast projections 314.2 that extend into and intimately contact the inner surfaces of the laminate stator retention features 322.3. In some embodiments, cast retention features 314.2 and 314.1 are generally opposite one another, although in yet other embodiments they are circumferentially spaced apart to minimize peak stresses within the cast sleeve 314. Preferably, the outermost retention features 314.1 are subsequently received within complementary-shaped retention features within a housing. In such embodiments, the retention features 314.1 transmit torque from the sleeve to the housing, whereas retention features 314.2 transmit torque from the stator assembly to the sleeve. As best seen in FIG. 11A, retention features 314.1 can be of a reduced length relative to the internal retention 314.2.

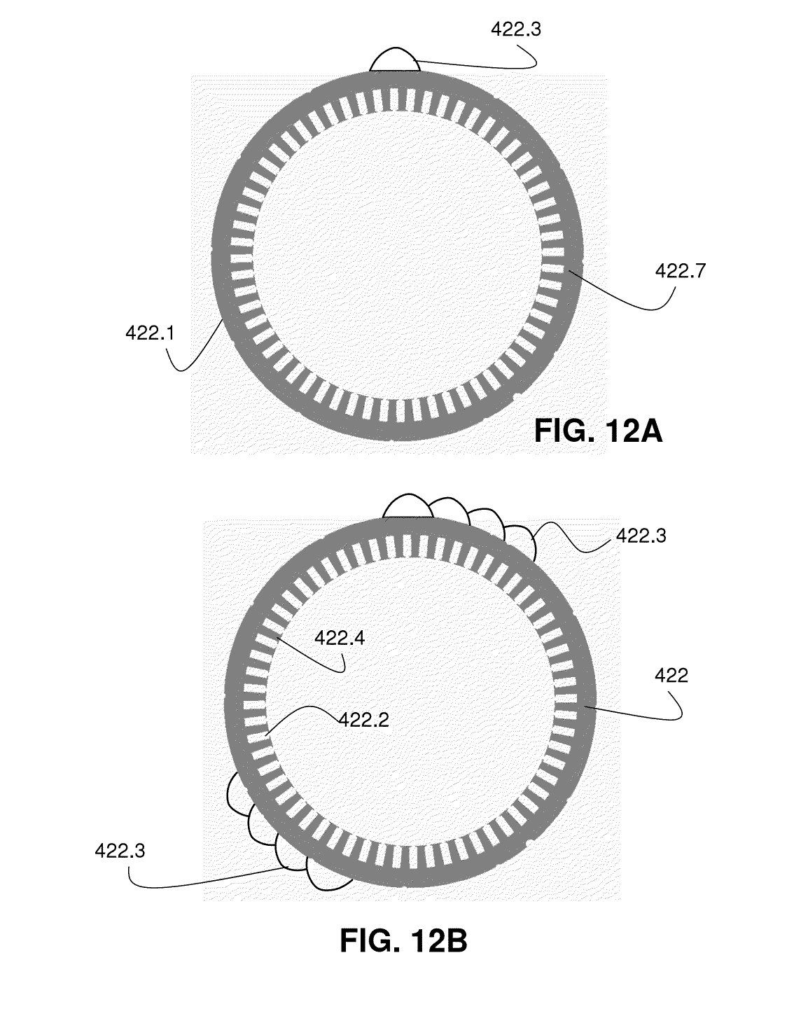

FIGS. 12A and 12B depict a laminate plate and stator assembly, respectively, according to another embodiment of the present invention. Laminate plate 422.7 includes a retention feature 422.3 placed at a location around the circumference of the outer diameter 422.1. Retention feature 422.3 is shown as a rounded projection, preferably stamped with other features of plate 422.7. However, the retention feature can also be of any shape, including recessed, or pocket-like shapes. Preferably, retention feature 422.3 is accurately located relative to slots 422.2.

In yet other embodiments, the retention features of the laminate plate assemblies include an outer diameter that is not concentric with the inner diameter of the stator. In some of these embodiments the stator plates are fabricated substantially identically, but during the assembly process, the plates are angularly registered relative to one another with an offset, such that the outer diameter of the assembled stator includes one or more recessed circumferentially-extending sectors. Within the angular extent of the sectors the outer diameters of the two adjacent stator plates are realized as steps or grooves in some embodiments.

FIG. 12B is a frontal view of an assembly 422 of eight plates 422.7. Each of the individual plates 422.7 include a retention feature 422.3. During assembly, each plate is angularly offset from each other plate, such that the plurality of retention features 422.3 extend circumferentially-spaced apart in a pattern. As shown in FIG. 12B, stator 422 includes a pattern in which four retention features are equally spaced apart from about 12:00 o'clock to 2:00 o'clock, and in which another plurality of retention features 422.3 are equally spaced apart from about 6:30 to 8:00 o'clock.

As a hybrid machined and cast subassembly 421 (not shown) is produced, the molten material of the sleeve or housing flows in and around the individual retention features 422.3. By spacing apart the torque retention features in both axial and circumferentially directions, it is possible in some embodiments to both minimize stress concentrations in the housing or sleeve, and further to increase the surface area of the stator assembly that is in intimate contact with the solidified cast material.

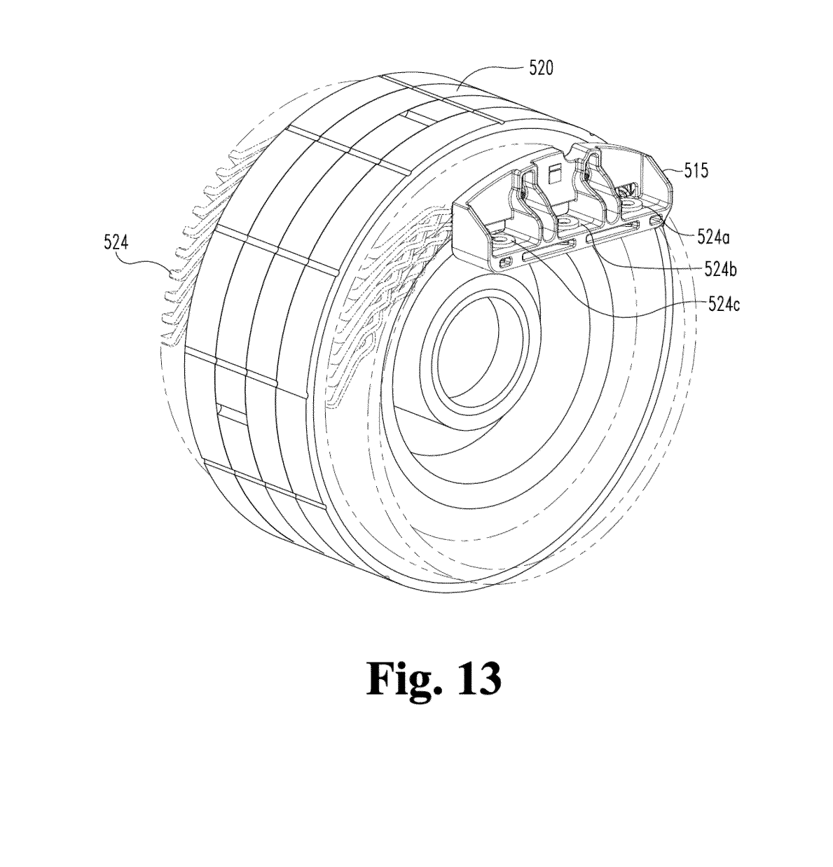

FIG. 13 illustrates components of a motor 510. Stator assembly 520 is substantially cylindrical with longitudinal pockets 522.2 extending through. Stator assembly 520 has inner diameter 522.4 and outer diameter 522.1. Rotor 550 is substantially coaxial with stator assembly 520 and separated from inner diameter 522.4 by a small air gap.

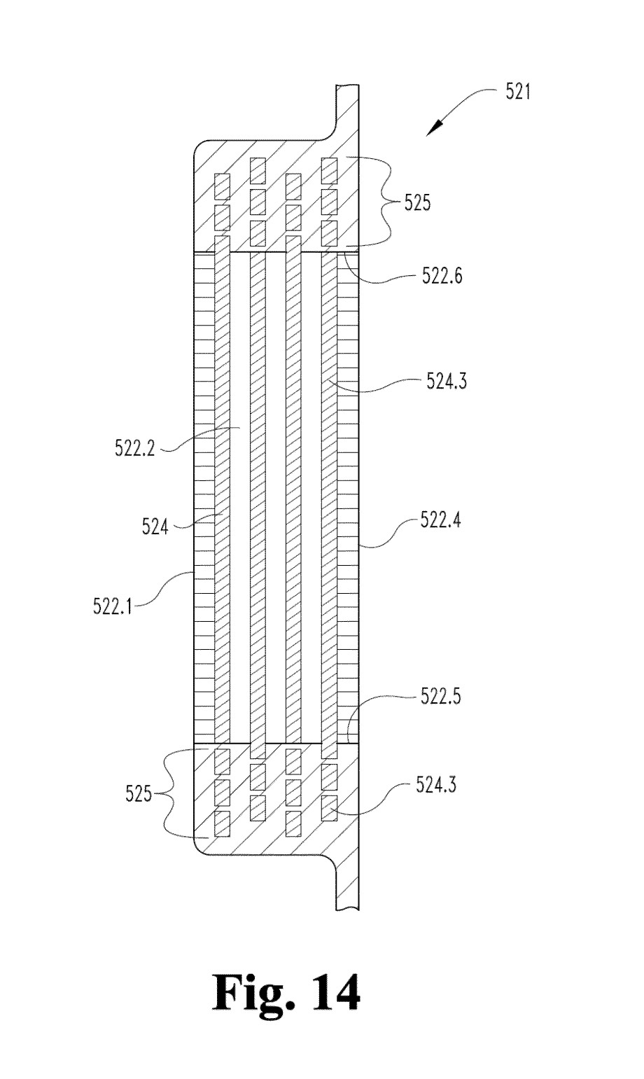

Turning to FIG. 14, stator assembly 520 is shown in cross-section with a slot or pocket 522.2 between the inner diameter 522.4 and outer diameter 522.1 through which four (4) conductors 524 pass. After a wire 524 leaves a passage of a pocket 522.2 (see also FIG. 13), it curves around a turn in a region 525 just past a face 522.5 and then passes through another slot or pocket 522.2. In some embodiments, distinct plurality of conductors 524 are inserted within a particular pocket 522.2, and ending at a terminal block 515 as will be understood by those skilled in the art. It is appreciated that in some embodiments the conductors 524 are arranged in three electrically distinct phases 524a, 524b, and 524c.

Those skilled in the art also understand that the turn portion 524.3 of the windings (preferably fabricated from a material containing copper) generates ohmic losses in the system. In some embodiments, however, at least the turn portions of conductor 524 are covered by an insulator 524.3, such as one of the ceramic insulators disclosed in U.S. patent application Ser. No. 13/236,685, which is hereby incorporated by reference. Application of ceramic or other insulation in various embodiments occurs preferably before conductors 524 are placed in passages 522.2 and positioned through turn regions 525 adjacent stator faces 522.5 and 522.6. In this illustrated embodiment, turn regions 525 are cast from a heat-conductive material, such as aluminum, during the process in which the housing 511 or the sleeve or similar part is cast. It is appreciated that the casting material may have a melting point lower than the melting point of the conductors, the insulation, the stator plates. Further, yet other embodiments contemplate the casting of a material that preferably has thermal conductivity greater than about five watts per degree Kelvin-meter. In yet other embodiments, more preferably the thermal conductivity is greater than about one hundred watts per degree Kelvin-meter.

Various embodiments allow heat from the turn portions of wires 524 to be disposed of through the heat-conductive casting material. Heat transferred through the casting material in some embodiments is transferred to a cooling passage or cavity 511.4 that is cast into the housing. Preferably passage 511.4 is integrally cast as the cast material solidifies around turn regions 525. However, the present invention also contemplates those embodiments in which a portion of the cooling passage is cast integrally with the cast material surrounding turn portions 525, in which case other components or processes are used to complete the cooling passage.

Various embodiments of the present invention contemplate any type of cooling medium C flowing within cavity 511.4, including air, gas, and solutions including oil, ethylene, or propylene. In some embodiments, the cooling passages include a plurality of fins that extend within the passage and serve to increase the surface area of the passage without substantial detriment to the flow characteristics of the passage. For example, cooling air can be passed over surfaces of the passage, or cooling fluid (such as water) can be moved along those surfaces to further remove heat from the system.

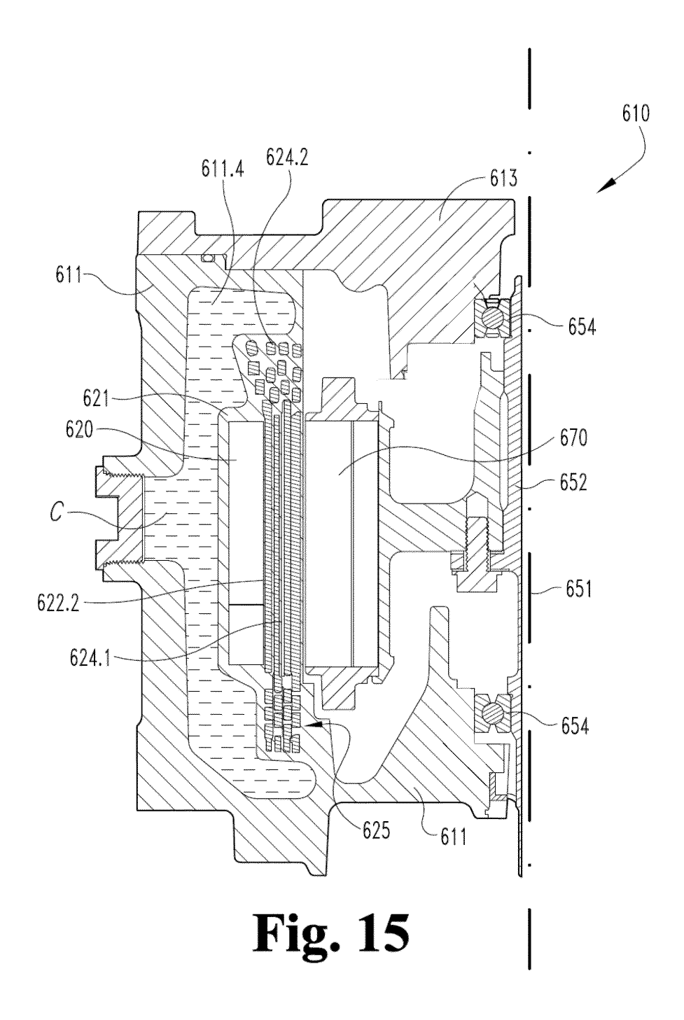

One example of this kind of heat removal is the embodiment illustrated as electric machine 610, shown in FIG. 15. FIG. 15 shows a partial cross sectional view of a portion of an electric machine 610. Machine 610 includes a rotor 650 rotatably supported by a pair of bearings 654 that are received within machine 610 with one bearing being supported by housing 611 and the other bearing 654 being supported by an end plate 613. Rotor hub 652 carries with it a plurality of magnets 670 arranged around the outer diameter of rotor 650. Rotor 650 rotates about the centerline 651 of machine 610.

Housing 611 is preferably cast in a single piece, this casting including the various features used for aligning and mounting motor 610 on a support frame. It is appreciated that housing 611 as shown in FIG. 15 is in a machined state after the casting operation is complete. Preferably, housing 611 is prepared from a hybrid subassembly 621 that includes the as-cast features of housing 611 surrounding a stator assembly 620.

In this embodiment, stator assembly 620 of motor 610 is positioned in proximity to rotor portion 650, separated by an air gap, and relative rotational movement between rotor and stator is enabled while they are kept in alignment by bearings 654. Stator assembly 620 houses conductor windings 624 in cast assembly 621, which in some embodiments is a hybrid fabrication including a fabricated stator 620 substantially surrounded by a cast housing 611. Coolant passage or cavity 611.4 is defined within housing 611. Coolant passage 511.4 includes heat exchange surfaces in proximity to turn region 625. In this way, heat from windings 624—especially heat from the turn portion 624.2 of windings 624 in turn region 625—is conducted efficiently through that part of the cast aluminum housing 611 to coolant within channel 611.4

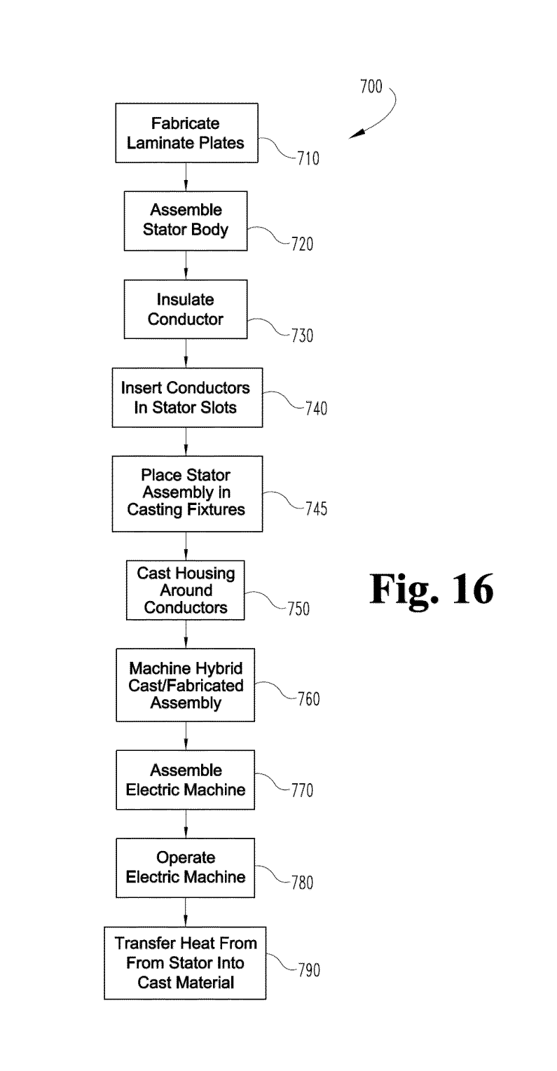

One process of manufacture 700 is illustrated as a flowchart in FIG. 16. This is only an example, however, and the principles of this disclosure can be applied without necessarily using all of these steps. In some embodiments, alternatives are substituted for the steps described in this example. Process 700 begins with the fabrication 710 of the laminate plates for the stator. In some embodiments, these laminate plates are stampings of a ferrous material, including stampings of tool steel. Preferably, the stamping process defines an outer diameter, inner diameter, and a plurality of circumferentially-spaced apart, axially-aligned slots or pockets therebetween

A plurality of plates are then assembled 720 into a stator body, such that the slots are in substantial alignment across the stack of plates. In some embodiments, the outer diameter of this stacked body is machined to a predetermined diameter and surface finish. In yet other embodiments various retention features are machined into the outer diameters. Yet other embodiments of the present invention contemplate the machining of various patterns of retention features that are adapted and configured for the viscosity and surface tension of a molten cast material, such that the molten material freely flows into the machined retention feature. In yet other embodiments the retention features are created on the outer diameter during stamping of the laminate plates. Further, it is understood that in some embodiments the stacked assembly of plates are assembled to create substantial alignment among the internal slots or pockets of adjacent plates, but which plates are angularly registered to one another such that one or more retention features on the outer surface of adjacent plates are not in substantial alignment.

Process 700 further includes insulating a plurality of conductor wires, preferably with an insulation material having a melting point that is higher than the melting point of the cast material to be later used. Preferably, this insulating material extends substantially along the entire length of the conductors, both inside the slots or pockets of the laminate plates and also into the end turn regions extending axially outward from the fore and aft faces of the stacked assembly. The insulated conductors are inserted 740 into the stator slots, preferably for three different phases of electrical power.

Following this partial assembly of the stator and conductive windings, this assembly is then placed within one or more casting fixtures. These fixtures preferably define one or more annular volumes adjacent the stator and faces, these annular volumes substantially encapsulating the conductor end turns in molten casting material. In some embodiments, the casting fixtures include provisions for cooling some portions of the stator.

A housing or sleeve is cast 750 around some or all of the stator subassembly. In yet other embodiments, the casting fixtures further establish a sleeve or housing having a wall that is in intimate contact with the outer surface of the stator subassembly. In such embodiments the casting fixtures facilitate the flow of molten material into any retention features fabricated into the outer surface of the stator subassembly. In still other embodiments, the casting fixtures further define an annular volume extending substantially around the stator subassembly that will later serve as a passageway for the flow of coolant.

Process 700 further includes machining 760 of the hybrid subassembly of the subassembled stator within the raw casting. Various features of the cast material are machined, including mounting features, features for locating one or more bearings, and the like.

The machined cast and fabricated subassembly is then assembled 770 into a functional electric machine, including the placement of bearings, a rotor, various connectors, and various connections and covers for the machine cooling system. During operation 780 of electric machine, heat is transferred 790 from the windings directly into the cast material, and thereafter into coolant C within the flow passage of the cast housing.

In some embodiments, no insulation is used on the winding wires, and the heat-conductive material is not substantially electrically conducting. In other embodiments, insulation is applied to the wires, and the heat-conductive material may or may not be electrically conductive.

In some embodiments, the heat-conductive casting material is made to contact the turn portions of the windings over substantially all of their surface area. In other embodiments, such care is not taken, and contact between the casting material and the turn portion of the windings is achieved over portions of the surface area of the windings.

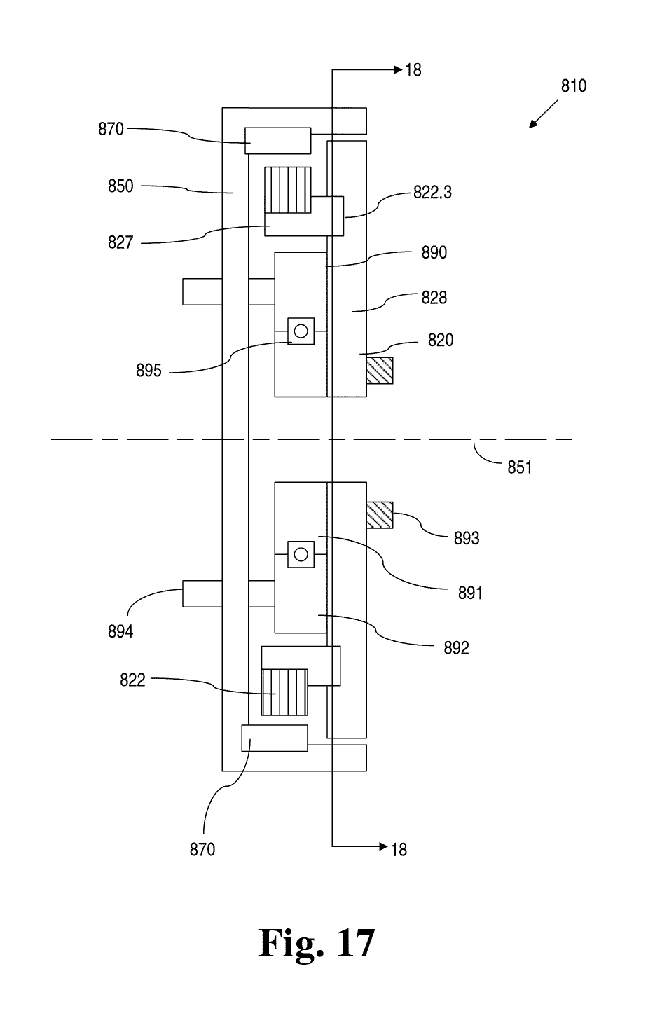

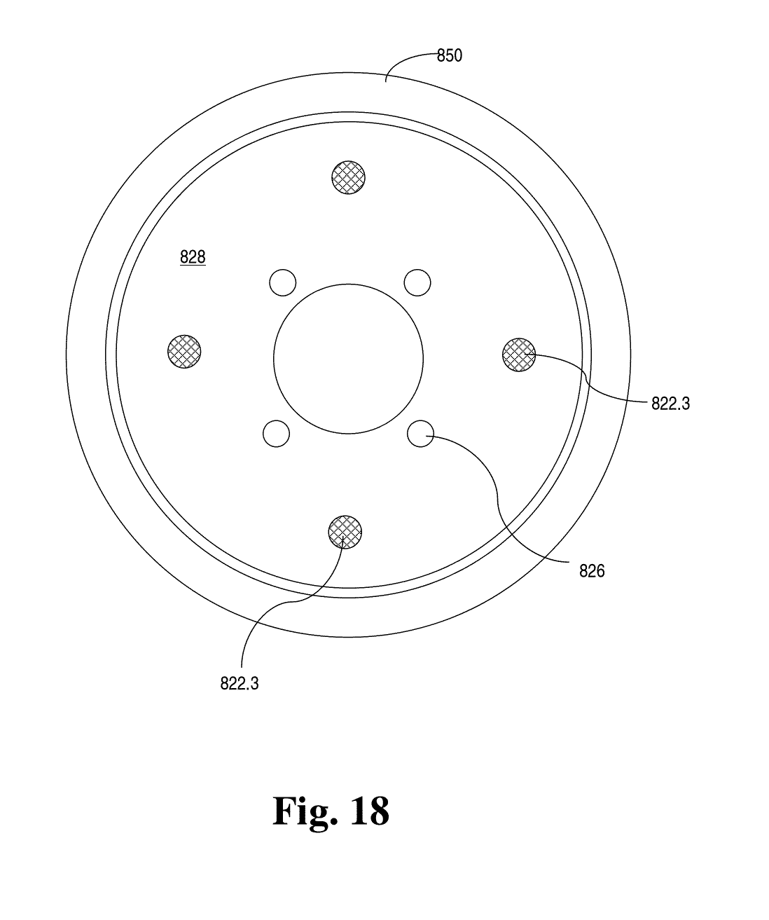

FIGS. 17 and 18 present schematic representations of a motor 810 according to another embodiment of the present invention. FIG. 17 shows a cross-section of motor 810 in a plane passing through the rotational axis 851 of the motor. Motor 810 includes a stator assembly 820 located generally within the inner diameter of a rotor assembly 850.

In some embodiments, motor 810 is mechanically coupled to a vehicle to provide motive power to the vehicle. FIG. 17 shows a hub assembly 890 that connects motor 810 to the suspension of a vehicle. Hub assembly 890 includes an inner stationary member 891 that supports a rotating outer member 892 by way of one or more bearings 895. Inner stationary member 891 includes a plurality of threaded inner studs 893 that pass through clearance holes 826 of stator 820 and fasten to the vehicle suspension (not shown). Outer rotating member 892 includes a plurality of threaded studs 894 that pass through clearance holes (not shown) of the housing of rotor assembly 850, and which further couple to the wheel of the vehicle (not shown).

Rotor assembly 820 includes a support ring 827 that has located within it a plurality of laminate subassemblies 822 spaced about the periphery of support ring 827. These laminate subassemblies 822 are provided a transient magnetic field by a plurality of conductors 824 (not shown), as generally described herein. Further as discussed previously herein, in some embodiments support ring 827 is cast integrally with laminate assemblies 822 and/or conductor assemblies 824.

Rotor assembly 850 includes a plurality of magnets 870, such as permanent magnets, located within an inner diameter of the housing of the rotor assembly, and passing close to the laminate assemblies 822, separated by an air gap.

Stator assembly 820 further includes a backing plate 828 that mechanically couples support ring 827 to the vehicle suspension (by way of inner studs 893). In some embodiments, backing plate 828 is mechanically connected to support ring 827 by a plurality of fasteners (not shown). As shown in FIGS. 17 and 18, in some embodiments backing plate 828 is cast while in contact with support plate 827 (with or without laminate assembly 822 or conductors 824). The reaction torque applied to laminate assemblies 822 and support ring 827 in such embodiments is passed by way of retention features 822.3 that extend into, and are cast within, backing plate 828. FIG. 18 shows these retention features 822.3 in cross-hatch. It is understood that although circular cross-section retention features are shown, the retention features can be of any shape, and further can include one or more separate keys 823 (not shown) that can substitute for one or more of the retention features 822.3.

An invention according to one embodiment of the present invention includes an apparatus for an electrical motor including a cylindrical rotor with magnets. The apparatus comprises a ring-shaped stator assembly adapted and configured for placement within the magnets and having an outer circumference with a plurality of slots. The assembly includes a retention feature on a surface of the assembly. The assembly includes a member in fixed relationship with the retention feature and the surface of said stator. The member is cast with the molten material being in substantial contact with the outer surface of said stator.

Although what has been shown and described herein is a hybrid subassembly including both cast and fabricated portions, in which the two portions are fabricated from materials of different melting points, yet other embodiments of the present invention are not so limited. In yet other embodiments the stator and the sleeve or housing can be fabricated from the same material (i.e., such as a steel stator surrounded by a cast steel or cast iron housing). Further, various embodiments herein are described such that the stator material has a higher melting point than the housing or sleeve material, but it is to be noted that various other embodiments are not so limited. In some embodiments the stator material and the housing or sleeve material have melting temperatures that are substantially similar. In such embodiments portions of the casting fixtures may be actively cooled. In yet other embodiments there may be sufficient time lag such that portions of the stator or conductors do not become too hot because of the temperature lag introduced by their own thermal mass.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. An apparatus for an electrical motor, comprising:
a cylindrical stator assembly having a length between opposite faces, an outer surface, an inner surface, and a plurality of circumferentially arranged slots; and
a member surrounding one of the inner surface or the outer surface of said stator and extending substantially along the length, said member being cast with the molten material being in substantial contact with the outer surface of said stator.

2. The apparatus of claim 1 wherein the one surface of said stator includes at least one feature having a first shape for transmitting torque from said stator to said member, a portion of the molten material having solidified in a second shape substantially complementary to the first shape.

3. The apparatus of claim 2 wherein said stator includes a plurality of features circumferentially spaced apart around the one surface.

4. The apparatus of claim 2. wherein the feature is a groove adapted and configured to receive the molten second material therein.

5. The apparatus of claim 2 wherein the feature is a projection adapted and configured to received the molten second material therearound.

6. The apparatus of claim 1 wherein said member is substantially cylindrical.

7. The apparatus of claim 6 wherein the one surface of said stator includes at least one groove extending along the one surface of said stator, and which further comprises a separate key having a width and placed within the groove, a portion of the width of said key extending radially outwardly from the one surface of said stator, the portion being substantially surrounded by the molten casting material.

8. The apparatus of claim 1 wherein stator assembly includes at least one electrically conductive winding, said winding extending at least partly within a slot, and said member is cast with the molten material being in substantial contact with a portion of said winding.

9. The apparatus of claim 1 wherein said member is a housing including features for mounting the machine on to a support structure.

10. The apparatus of claim 1 wherein said member is a housing including a coolant passageway for cooling the machine.

11. The apparatus of claim 1 wherein the length of said member extends past each face of said stator.

12. The apparatus of claim 1 wherein said stator assembly comprises a plurality of substantially identical plates.

13. The apparatus of claim 12 wherein said plates are assembled into said stator assembly, and the outer surface of said assembly is not machined prior to the casting of said member.

14. The apparatus of claim 12 wherein said plates are stamped and the molten material is in substantial contact with the as-stamped outer surfaces.

15. The apparatus of claim 12 wherein the outer surface of each said plate is non-circular.

16. The apparatus of claim 15 wherein said plates are assembled with a predetermined angular offset relative to one another such that the outer surface of said stator assembly has a configuration that is different than the configuration of the outer surface of an individual said plate.

17. The apparatus of claim 12 wherein each plate has an inner diameter, and the outer surface of each plate is circular about an axis that is spaced apart from the axis of the inner diameter.

18. The apparatus of claim 17 wherein said plates are assembled with a predetermined angular offset relative to one another such that the outer surface of said stator assembly has a configuration that is different than the configuration of the outer surface of an individual said plate.

19. The apparatus of claim 1 wherein said member is a thin-wall sleeve.

20. The apparatus of claim 19 which further comprises a housing having an interior, the exterior of said sleeve being received within the interior, said housing including features for mounting the machine.

21. The apparatus of claim 19 wherein said stator includes at least one groove extending along at least a portion of the length, the molten material of said sleeve solidifying within the groove, said sleeve further including at least one projection extending radially outwardly from the outer surface of said sleeve.

22. The apparatus of claim 19 which further comprises a housing having an interior and features for mounting said machine on a vehicle, the exterior of said sleeve being received within the interior and including at least one projection, said housing including a groove adapted and configured to receive therein the projection of said sleeve.

23. The apparatus of claim 1 wherein said stator is fabricated from a first material, said member is cast from a second material, and the melting point of said second material is lower than the melting point of said first material.

24. The apparatus of claim 23 wherein said stator assembly includes a plurality of electrically conductive windings, each said winding including a body portion that extends within a slot, and a turn portion that joins two or more body portions outside of the slots.

25. The apparatus of claim 23 wherein said conductive windings are fabricated from a third material having a melting point that is higher than the melting point of said second material, the molten second material being in contact with a portion of said turn portions.

26. The apparatus of claim 25 wherein the portion of said turn portions in contact with the molten second material are covered with a ceramic material.

27. The apparatus of claim 1 wherein said cylindrical assembly includes a cylindrical member having a cavity proximate to the turn portions, the cavity being adapted and configured to transfer heat away from the turn portions.

28. The apparatus of claim 27 wherein the cavities are adapted and configured for cooling by a liquid.

29. The apparatus of claim 27 wherein the cavities are adapted and configured for cooling by a gas.

30. The apparatus of claim 27 wherein said member includes a plurality of fins extending within the cavity.

31. A method of making an electric machine, comprising:
fabricating a stator having a stator body and at least one electrically conductive winding, each winding including a plurality of body portions that each pass through the stator body and a plurality of turn portions joining the body portions outside the stator body; and
casting a material to substantially fill a volume that contains at least part of the turn portions.

32. The method of claim 31 wherein said fabricating a stator body is with a ferrous material, and said casting a material is with aluminum.

33. The method of claim 30 which further comprises providing at least one casting fixture, and the fixture provides at least some of the boundaries of the volume.

34. The method of claim 31 wherein said casting a material includes defining a cavity for passage of coolant with cast walls that substantially surrounds one of the turn portions or the stator body.

35. The method of claim 31 which further comprises stamping a plurality of substantially identical plates, and stacking together a plurality of the plates when assembling the stator bodies.
